(19) United States
(12) Patent Application Publication
(10) Pub. No.: US 2018/0172571 A1
(43) Pub. Date: Jun. 21, 2018

(54) DETERMINING FLUID DENSITY WITHIN A TANK

(71) Applicant: Simmonds Precision Products, Inc., Vergennes, VT (US)

(72) Inventors: Giusi Quartarone, Cork (IE); Raymond Foley, Cork (IE)

(21) Appl. No.: 15/827,226

(22) Filed: Nov. 30, 2017

(30) Foreign Application Priority Data
Dec. 2, 2016 (EP) 16202065.5

(51) Int. Cl. G01N 9/26; G01L 15/00; G01L 19/00; G01F 23/14

(52) U.S. Cl. CPC G01N 9/26; G01F 23/14; G01L 19/0076; G01L 15/00

(57) ABSTRACT

Methods of determining fluid density within a tank, such as an aircraft tank are include installing one or more clusters of sensors each cluster comprising a plurality of sensors including at least one pressure sensor. A minimum of two pressure measurements are required for density estimation. The fluid density between different clusters may be determined from pressure measurements obtained by each cluster and the distance between the clusters. Furthermore, the distribution of density throughout the tank may be determined by employing clusters including two or more pressure sensors.

### FOREIGN PRIORITY

This application claims priority to European Patent Application No. 16202065.5 filed Dec. 2, 2016, the entire contents of which is incorporated herein by reference.

### TECHNICAL FIELD

The present disclosure relates generally to methods of gauging a fluid within a tank and particularly to methods of determining fluid density within the tank using pressure measurements. In some embodiments, the present disclosure relates to methods of determining fuel density within an aircraft fuel tank.

### BACKGROUND

There are various situations where it may be desired to measure one or more properties of a fluid within a tank and/or to gauge the amount of fluid within the tank. For example, it may be desired to gauge the amount of fuel within an aircraft fuel tank in order to determine when and to what extent the aircraft must be refuelled.

Accurately gauging the fuel within an aircraft fuel tank can present certain difficulties, especially due to the changes in orientation or attitude of the fuel tank during the flight of the aircraft. The temperature and the composition of the fuel may also vary across the tank, e.g. dependent on proximity to the motors, or where the aircraft has been fuelled with different types of fuel, which may not mix well. The changes in attitude of the tank also mean that the regions of different temperatures/fuel composition may move around the tank. It will be appreciated that these difficulties may be quite specific to aircraft fuel tanks, and do not necessarily apply, or at least not to the same extent, to fuel tanks in other motor vehicles such as cars.

In some conventional fluid gauging systems, capacitive type sensing probes are used wherein the capacitance of the probe changes in proportion to the amount of fluid in the tank, due to the different dielectric constants of the fluid and air. Since the dielectric constant of the air is typically lower than that of the fluid (e.g. where the fluid is a fuel), the probe exhibits a lower capacitance when partially submerged in the fluid compared to a totally submerged probe. However, when the fluid reaches the top of the probe, the probe becomes inactive, as the output will then remain the same regardless of the amount of fuel in the tank.

To overcome this limitation, it is known to conceptually divide the tank into a number of sub-volumes each having a respective probe. Thus, multiple probes must be installed within the tank, and the installation and replacement time may be relatively high. For example, in a typical passenger aircraft, more than 30 probes may need to be installed within the fuel tank(s), with an installation time of tens of hours.

It is also known to use pressure sensors for gauging fluid. However, again, conventional approaches may require a large number of individual pressure sensors to be installed.

In order to accurately gauge the fluid within the tank, it may be useful to first determine the density of the fluid. The density of the fluid may also be of interest in itself, e.g. for performance analysis and/or diagnostic purposes. In some known approaches, the fuel density may be measured using a dedicated densitometer installed within the tank. In other known approaches, an assumed or expected value may be used.

### SUMMARY

From a first aspect there is provided a method of determining a density of a fluid within a tank such an aircraft fuel tank, the method comprising: installing a first cluster of sensors at a first location within the tank, wherein the cluster of sensors comprises a plurality of sensors including at least two pressure sensors, and wherein the plurality of sensors within a cluster are installed simultaneously on a common frame or housing; obtaining a first pressure measurement of the fluid within the tank using one or more of the pressure sensors of the first cluster of sensors; and determining a density of the fluid using the obtained first pressure measurement.

The first cluster of sensors may comprise first and second spaced apart pressure sensors, and the method may comprise determining the fluid density at the first location by determining the fluid density between the first and second pressure sensors using pressure measurements obtained from the first and second spaced apart pressure sensors and the distance between the first and second pressure sensors measured in a direction perpendicular to the surface of the fluid.

The method may further comprise obtaining a second pressure measurement of the fluid at a second location within the tank, wherein the second location is different from the first location and spaced apart from the first cluster of sensors, and using the obtained first and second pressure measurements and the distance between the first and second locations, measured perpendicular in a direction to the surface of the fluid, to determine the fluid density within the tank between the first and second locations.

The method may comprise installing a second cluster of sensors at the second location within the tank, the second cluster of sensors comprising a plurality of sensors including at least two pressure sensors, wherein the plurality of sensors within the cluster are installed simultaneously on a common frame or housing, and wherein the second pressure measurement of the fluid is obtained using one or more of the pressure sensors of the second cluster of sensors.

It will be appreciated that the first and second locations are generally known locations. For instance, the position(s) at which the pressure sensors or clusters are installed will generally be known and/or pre-determined such that they can be used in the determination of the fluid density. The method may further comprise installing a third or further cluster of sensors within the tank and obtaining a third or further pressure measurement using the third or further cluster of sensors.

The method may comprise determining a distribution of fluid density within the tank by installing a plurality of clusters of sensors at a plurality of different locations throughout the tank, and determining the fluid density at each of the locations using pressure measurements obtained from first and second pressure sensors of each respective cluster of sensors.

The method may comprise determining an orientation of the fuel tank and/or the cluster of sensors relative to the fluid surface. Optionally the method may comprise determining the distance between the first and second pressure sensors or between the first and second locations, measured in a direction perpendicular to the surface of the fluid, based on the determined orientation of the fuel tank and/or cluster. One or more sensors and/or processors may be provided for determining the orientation of the fuel tank and/or the cluster of sensors relative to the fluid surface.

The method may further comprise determining a volume, mass or level of fluid within the tank using the determined fluid density.

The density of the fluid, ρ, may be determined using a relationship,

$$ρ = \frac{{p}_{1} - {p}_{2}}{{ah}_{s}} ,$$

where p₁ and p₂ are pressure measurements obtained at two different positions within the tank, hₛ, is the distance between the two positions measured in a direction perpendicular to the surface of the fluid, and the fluid is subject to an acceleration, a.

The method may comprise: installing the first cluster of sensors at the first location within the tank; installing a second cluster of sensors at a second location within the tank, wherein the second cluster of sensors comprises a plurality of sensors including at least two pressure sensors, and wherein the plurality of sensors within the second cluster are installed simultaneously on a common frame or housing; obtaining pressure measurements of the fluid using the pressure sensors of the first and second clusters of sensors; determining a density of the fluid at the first location by determining the density of the fluid between a pair of pressure sensors of the first cluster of sensors; determining a density of the fluid at the second location by determining the density of the fluid between a pair of pressure sensors of the second cluster of sensors; and determining a density of the fluid between the first and second locations using pressure measurements obtained from the first and second cluster of sensors.

From another aspect there is provided a pressure gauging system for determining the density of fluid within a tank such as an aircraft fuel tank, the system comprising: one or more clusters of sensors, wherein each cluster of sensors comprises a plurality of sensors including at least two pressure sensors provided on a common frame or housing such that the plurality of sensors within each cluster can be installed simultaneously; and one or more processors for receiving pressure measurements of the fluid from the pressure sensors of the one or more clusters of sensors, and processing the received measurements to determine a density of the fluid.

The system may comprise two or more clusters of sensors.

In general, the system may comprise any or all of the features described herein in relation to the other aspects or embodiments. In particular, the one or more processors may be configured to perform any of the method steps described herein.

From a further aspect there is provided a cluster of sensors for use in a method or system substantially as described herein, the cluster of sensors comprising: a mounting or housing; and a plurality of sensors including two or more pressure sensors provided on the mounting or housing.

The cluster of sensors may additionally include other types of sensor, which may also be provided on the mounting or housing.

From a further aspect there is provide an aircraft or aircraft fuel tank comprising a system and/or one or more clusters of sensors substantially as described herein.

In accordance with any of the aspects or embodiments disclosed herein, each pressure sensor may comprise a solid state and/or micro-electro-mechanical system (“MEMS”) pressure sensor.

In accordance with any of the aspects or embodiments disclosed herein, each cluster of sensors may comprise a substantially closed housing, wherein the plurality of sensors are mounted within the housing, and wherein the at least two pressure sensors have a pressure sensing surface that forms part of the exterior surface of the housing.

The housing may also contain suitable electrical circuitry for supplying power and/or for receiving measurement data from the plurality of sensors. In embodiments, the plurality of sensors may share common circuitry. For example, the cluster of sensors may have a single input/output cable, or a single input and a single output cable.

The housing may optionally also contain one or more other sensors, one or more data storage devices, one or more processors for processing measurement data, one or more transmitters for transmitting measurement data to an external processor or storage device.

### BRIEF DESCRIPTION OF THE DRAWINGS

Various embodiments will now be described, by way of example only, and with reference to the accompanying drawings in which:

FIG. 1 illustrates a fuel gauging system and a method of determining fuel density using the fuel gauging system;

FIG. 2 illustrates a cluster of sensors that may be used within a system like that shown in FIG. 1;

FIG. 3 illustrates the cluster of sensors of FIG. 2, but arranged with a different attitude relative to the fuel surface; and

FIG. 4 illustrates a cluster of sensors according to another embodiment that may suitably be used for the techniques described herein.

### DETAILED DESCRIPTION

In embodiments according to the present disclosure, a plurality of sensors may be installed together in a single package, or “cluster”. A cluster of sensors therefore comprises a plurality of sensors mounted on or within a common frame or housing. The cluster may also contain any associated electronics or electrical connections or wiring for the sensors, and optionally various processing circuitry, or transmission circuitry for transmitting measurements to an external processor. The cluster may thus be sold to a user effectively as a “black box” ready for immediate installation into a fluid tank, having all of the desired components pre-packaged and pre-arranged inside.

Because a plurality of components are clustered together prior to installation, ready for installation as a single package, the installation and maintenance time for the components may be significantly reduced as the multiple sensors within each cluster can be installed simultaneously, essentially in a single step. For instance, the installation time for a cluster of sensors may be substantially the same as the installation time for an individual sensor. Similarly, because the sensors within the cluster may share common electrical or electronic components, the wiring for the sensor may be simpler (and the installation time shorter) than the wiring required for installing the same number of sensors individually. For instance, a single wire bundle may be routed to the cluster, thus reducing the number of wire mounts or hangers required for the plurality of sensors. Furthermore, because the various sensors and wiring may be packaged together outside of the tank, prior to installation, it is relatively easy to control the relative positions of the sensors, and there is a reduced risk of misalignment due to installation errors. The clustering may also therefore serve to increase the accuracy of the measurements obtained using the sensors.

The techniques disclosed herein for determining fluid density rely on pressure measurements of the fluid. A cluster of sensors according to the present disclosure comprises two or more pressure sensors packaged together. A density of the fluid may thus be determined using the pressure measurements obtained by one or more pressure sensor of the cluster of sensors. By determining a density of the fluid using the obtained pressure measurements, it will be understood that the fluid density may be determined based at least in part on a pressure measurement obtained by one or more pressure sensors of the cluster. The fluid density may be determined using the pressure measurement in combination with e.g. other pressure measurements, or other measured or known properties of the system/fluid.

Pressure measurements may be particularly suitable in this context because the pressure exerted anywhere in an uncompressed fluid, such as the fluid within the tank, is transmitted equally in all directions through the fluid. Pressure sensors can therefore work for the entire volume range of the tank, such that it may no longer be necessary to conceptually split the fuel tank into a number of sub-volumes that are each measured individually.

The pressure sensors may, at least in some embodiments, comprise MEMS pressure sensors as these have been found to have particularly suitable characteristics for use with the techniques described herein. However, the skilled person will be aware of various types of pressure sensors, and it will be appreciated that various suitable sensor types may be used with the techniques described herein.

It will be understood that in order to obtain a pressure measurement of the fluid, the cluster must be at least partially submerged in the fluid. That is, the location at which the cluster is installed must lie below the fluid level such that the pressure sensor(s), or at least the pressure sensing surfaces thereof, within the cluster are exposed to the fluid. Where the sensor is not exposed, no valid measurement of the fluid can be performed, and the pressure sensor will simply measure the ambient pressure in the tank. In this case, it may be determined that the fluid level is below the location of this pressure sensor. This information may also be used to help gauge the fluid level.

In embodiments, the clustering together of two or more pressure sensors may allow more accurate pressure measurements of the fluid to be obtained without increasing the installation time, or the accuracy of the individual sensors. For instance, the pressure measurements from the two or more pressure sensors within the cluster, which may all be associated with substantially the same first location, may be combined together to provide a higher signal, or higher signal-to-noise ratio. It will be appreciated that the pressure measurements from the different sensors within the cluster may be combined taking into account their relative orientations and distances to the fuel surface to provide a more accurate pressure measurement. Alternatively, or additionally, the fluid densities determined using each of the pressure measurements from the individual sensors within the cluster may be averaged or combined together to provide a more accurate fluid density determination. The measurements may be averaged or combined in various suitable ways to enhance the accuracy. Thus, by clustering at least two pressure sensors together, it is possible to achieve an increase in accuracy without having to increase the accuracy of the individual sensors themselves.

Furthermore, clustering two or more pressure sensors may provide a redundancy such that in the event of failure of one of the pressure sensors, it may still be possible to obtain pressure measurements associated with the first location.

In general, a cluster of sensors may comprise any number and kind of sensors. For instance, the cluster may comprise two, three, four or more, pressure sensors, wherein pressure measurements may be obtained independently from each of the pressure sensors within a cluster. The pressure measurements from each pressure sensor within a cluster may then be used in combination with pressure measurements from the other pressure sensors within the cluster or with pressure measurements from other pressure sensors within the tank in order to determine a fluid density.

It will be appreciated that all of the sensors within a cluster may be located in relatively close proximity (i.e. relative to the size of the tank). Typically, the cluster, and/or the spacing of the pressure sensors within the cluster, may be less than about 1 meter, for instance, between about 0.1 and 1 meters, such as between about 0.1 and 0.5 meters, dependent on the size of the tank. The relative positioning of the sensors within a single cluster may generally be well-defined and controlled during the manufacture of the cluster. For instance, if the cluster is installed such that one of the pressure sensors is located at a particular first location, the other pressure sensors within the cluster may be located relatively close to the first location, at a known and pre-determined distance away from the first location, such that the measurements may each be associated with each other. The measurements from the different sensors may be combined together, as mentioned above, in which case, the measurements may each be associated with an effective location, e.g. lying equidistant between the various sensors. Thus, by obtaining a pressure measurement at a certain location, it will be understood that the location may comprise a location where a pressure sensor is actually installed, or may comprise a location that may otherwise be associated with one or more pressure sensors.

The pressure measurement(s) obtained using the cluster of sensors may generally be used to determine various properties of the fluid including, but not limited to, fluid mass, fluid level and fluid volume. Thus, the methods and techniques disclosed herein may generally comprise a further step of determining a volume, mass or level of the fluid within the tank. This step may comprise using, at least in part, a density of the fluid determined using the pressure measurements.

Particularly, however, as mentioned above, the cluster of sensors is used to determine a density of the fluid within the tank. According to the techniques described herein, the density may be determined using the pressure measurements, thus avoiding the need to install a separate, and typically relatively expensive, densitometer.

For example, because multiple pressure sensors are packaged together within each cluster, a ‘local’ fluid density in the vicinity of each cluster may be determined using the pressure measurements obtained from the pressure sensors within a single cluster and the distance between the sensors within the cluster. That is, each cluster may by itself allow the fluid density in the vicinity of the cluster to be determined. In general, the relative positioning of the sensors within a particular cluster may be selected during the manufacture of the cluster and fixed with a high degree of accuracy. The distance between the sensors measured in a direction perpendicular to the surface of the fuel may then be determined based on knowledge of the relative positions of the sensors within the cluster and of the attitude or orientation of the tank and/or sensors relative to the surface of the fluid (e.g. as defined by the fluid/air boundary within the tank). Thus, where the first cluster of sensors comprises first and second spaced apart pressure sensors, the fluid density at the first location may be determined by determining the fluid density between the first and second pressure sensors using pressure measurements obtained from the first and second spaced apart pressure sensors and the distance between the first and second pressure sensors measured in a direction perpendicular to the surface of the fluid. Where a cluster comprises more than two, e.g. three or more, pressure sensors, it will be appreciated that a density may be determined between each pair of sensors within the cluster. These values may then be averaged to give the local fluid density at the location where the cluster is installed.

As another example, a density may be determined using the pressure measurement(s) obtained using a first cluster installed at a first location in combination with a pressure measurement obtained at a different location within the tank, e.g. a second location away from the first cluster. For instance, a plurality of clusters may be distributed through the fluid tank, with the different clusters being installed at different spaced apart locations within the tank. Pressure measurements obtained from the different clusters may thus be used in combination with the known or measured distance between the clusters (the distance being perpendicular to the fluid level) in order to determine what is effectively an average or ‘global’ fluid density within the tank, or more specifically within the region between the different clusters. The relative positions of the different clusters within the tank may be selected to ensure a sufficiently large measurement coverage across the volume of the tank whilst minimising the overall number of clusters that need to be installed. The relative positions may e.g. be substantially optimised based on empirical or theoretical considerations, or using simulations. The number and relative positions of the clusters within the tank may be selected to ensure that a sufficient number of clusters remain submerged (or remain submerged for as long as possible) as the fluid surface changes over time relative to the positions of the clusters/sensors either as the fluid is used up or due to changes in attitude or orientation of the fluid tank e.g. in an aircraft fuel tank due to the flight of the aircraft. Thus, in some embodiments, second, third or further clusters of sensors may be installed at different respective locations within the tank to ensure maximum coverage. The fuel density may thus be determined using any or all of the pressure measurements from the first, second, third or further clusters of sensors. For instance, where three or more clusters of sensors are installed, the fluid density may be determined between the first and second clusters, between the second and third clusters, and between the first and third clusters, with these values being averaged to determine the fluid density within the tank. Additionally, providing further clusters allows a more detailed determination of the fluid density distribution within the tank.

In general, it will be appreciated any pair of pressure sensors within the tank may be used to determine a density of the fluid, as long as both sensors within the pair are submerged in the fluid. For instance, as described above, a fluid density may be determined using two pressure sensors within a single cluster and/or using two pressure sensors within different clusters. Thus, by installing multiple clusters of sensors at first and second locations within the tank, each cluster comprising at least two pressure sensors, it is possible to create a system that is capable of providing a large amount of information about the density and density distribution within the tank. For example, the local densities in the vicinity of each of the clusters (i.e. at or around the locations where the clusters are installed) may be determined using pairs of sensors from each individual cluster, with the local densities at the different locations then used to provide information about the distribution of fluid density within the tank. Furthermore, pressure measurements from each pressure sensor within a particular cluster may be combined in a pairwise manner with pressure measurements from each of the pressure sensors of the other clusters to additionally determine the fluid density between each of the clusters. Information regarding the local density around each of the clusters, or the fluid density distribution through the tank, may be highly complementary to the average density of the fluid in the tank, as determined between the different clusters. For instance, as explained below, the error associated with the fluid density determination may be inversely proportional to the spacing between the pressure sensors used to determine the fluid density. Using the pressure measurements obtained between the different spaced apart clusters may thus allow for the density to be determined with a relatively high accuracy. On the other hand, as the distance between the pressure sensors increases, the fluid density may no longer be uniform. Thus, knowledge of the density distribution may be useful in order to improve the confidence in the density determinations. Furthermore, as the distance between the pressure sensors increases, the probability of having the pressure sensors of the different clusters simultaneously submerged decreases. It is thus useful to be able to determine multiple fluid densities over different distances (i.e. between different pairs of sensors) within the tank.

The density distribution within the tank may therefore be a useful parameter to enhance the accuracy of measurements or estimations based on the fluid density, such as estimates of the fluid level or volume. However, knowledge of the density distribution may also be useful in itself e.g. for analysing performance and/or diagnosing faults within the tank.

In some embodiments, the fluid is a fuel, and the fluid tank is an aircraft fuel tank. For these embodiments, any references to a fluid used herein may refer to a fuel. It will be appreciated that the fuel within an aircraft fuel tank may exert a relatively wide range of pressures, in part due to the acceleration of the tank during flight of the aircraft. It will also be appreciated that aircraft fuel tanks are relatively large. In this context, it may therefore be especially important to increase the accuracy of the pressure measurements, whilst still minimising the overall installation time, etc. Furthermore, the fuel density distribution within an aircraft fuel tank would not be expected to be uniform due to the potential regions of different temperature/fuel composition and the movement of the fuel due to the changes in attitude of the tank during the flight.

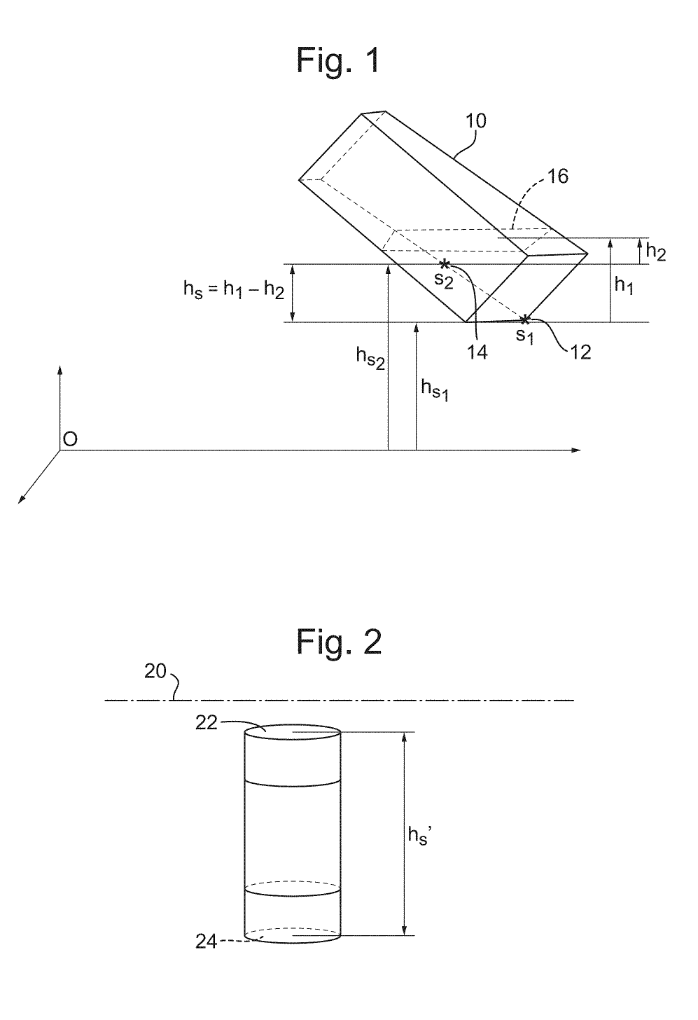

FIG. 1 illustrates a pressure gauging system according to the present disclosure for determining a fuel density within an aircraft fuel tank. As shown in FIG. 1, installed within the tank 10 at first and second fixed locations respectively are first 12 and second 14 clusters of sensors. Although FIG. 1 illustrates only first and second clusters, it will be appreciated that any number of clusters and/or pressure sensors may be installed within the tank 10. In general, the more sensors installed within the tank the greater the possible measurement coverage across the tank. However, by appropriately selecting the positions of the sensors within the tank, it is possible to ensure a large coverage whilst keeping the number of clusters reasonably low.

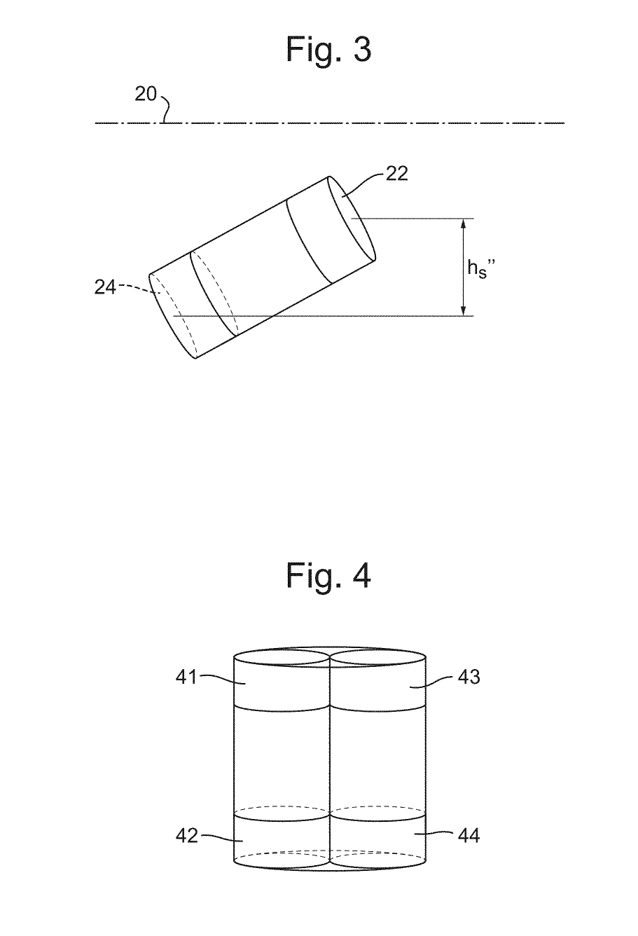

As explained above, each cluster of sensors comprises a plurality of sensors within a single package or housing, such that the cluster can be installed in a single step. The time to install a cluster may thus effectively be the same as the time to install a single sensor. The plurality of sensors comprises at least two pressure sensors mounted within the same package. A cluster of sensors comprising two pressure sensors 22,24 is illustrated in FIGS. 2 and 3. However, it will be appreciated that any number of pressure or other sensors may be clustered together within a single package as desired. For instance, FIG. 4 shows a cluster of four pressure sensors 41,42,43,44 within a single package. As shown in the figures, the cluster may comprise a closed package, with the pressure sensing surfaces of the pressure sensors facing outwardly, such that they are exposed to fluid when the cluster is submerged. The electrical connections, and optionally any other sensors or processing circuitry may also be contained within the package. It will be appreciated that because the package is assembled prior to installation, it is relatively easy to control the relative positions of the various sensors and to ensure that the sensors are properly connected. It will also be appreciated that the electrical connections or wiring for the cluster may be less complex than for a plurality of separately installed sensors, as the sensors within each cluster may utilise common components or wiring. For instance, the cluster may comprise only a single input and/or output connection that is shared by each of the plurality of sensors to further facilitate the installation of the plurality of sensors. The use of a cluster may thus help to reduce installation error, as well as installation time.

Clustering multiple pressure sensors together into a single package may also allow an effective increase in the accuracy of the pressure measurements, without e.g. having to use more accurate (and expensive) sensors. Thus, the techniques described herein may in some embodiments allow the number of components that need to be installed within the tank to be reduced, whilst still allowing an accurate estimation of the fuel mass or density.

For instance, pressure measurements from different sensors within the cluster may be combined together, to provide a higher signal or signal-to-noise ratio. Alternatively, the measurements from the different sensors within each package may each be used in combination with measurements from sensors with other packages (installed at other locations) to give a plurality of density values, in the manner described below, with these density values then being averaged. Additionally, providing multiple pressure sensors within a single package helps ensure a degree of redundancy, such that in the event of failure of a single pressure sensor, pressure measurements may still be taken from other sensors within the cluster.

Thus, referring back to FIG. 1, the pressure sensor(s) of the first cluster 12 may provide a first pressure p₁ at the first location, while the pressure sensor(s) of the second cluster 14 may provide a second pressure p₂ at the second location. As shown in FIG. 1, the first 12 and second 14 pressure sensors are distributed across the volume of the tank 10 such that they are spaced apart by a certain (fixed) distance.

With the tank 10 oriented as shown in FIG. 1 and the fuel level shown in the same picture, both of the first 12 and second 14 clusters are fully submerged within the fuel, i.e. both lie below the surface of the fuel 16. Particularly, the pressure sensors of the first cluster 12 lie a first distance h₁ below the fuel surface 16 and the pressure sensors of the second cluster 14 lie a second distance h₂ below the fuel surface 16. The distance between the pressure sensors of the first and second clusters along the direction perpendicular to the fuel surface is thus hₛ=h₁−h₂.

The density of the fuel within the tank 10 may be estimated using the pressures at the first and second locations measured respectively by the pressure sensors of the first 12 and second 14 clusters, and the distance between the pressure sensors of the first and second clusters along the direction perpendicular to the fuel surface, hₛ, as explained below.

### Estimating Fuel Density Using Distributed Sensors

Let define p₁ as the pressure exerted over a unit area s₁ by a column of fuel h₁ with a density ρ, subject to an acceleration a and ambient pressure p₀ (see e.g. FIG. 1, where the first sensor 12 is installed at the position of the first unit area s₁ and the second sensor 14 is installed at the position of the second unit area s₂)

p₁=βah₁+p₀ Equation (1)

Similarly, the pressure exerted by the fuel over a unit area s₂ is

p₂=ρah₂+p₀ Equation (2)

where a and p₀ do not depend on the location but rather on the external conditions, and wherein ρ represents the average density between the two locations.

### Therefore,

$$ρ = \frac{{p}_{1} - {p}_{2}}{a ( {h}_{1} - {h}_{2} )} = \frac{{p}_{1} - {p}_{2}}{{ah}_{s}} = \frac{{p}_{1} - {p}_{2}}{a ( {h}_{{s}_{1}} - {h}_{{s}_{2}} )} \qquad Equation ( 3 )$$

where hₛ represents both the distance between the fuel heights h₁ and h₂ and the difference between the heights of unit areas hₛ_{₁} and hₛ_{₂} with respect to an external reference system (see FIG. 1).

Therefore, supposing to know the positions of the unit areas hₛ_{₁} and hₛ_{₂} (that will represent the positions where the sensors or clusters will be installed), the fuel density can be estimated.

In some embodiments, these values may then be used to estimate the fuel heights h₁ and h₂ that represent an indirect fuel quantity measurement.

Since the fuel surface changes direction with the aircraft acceleration, the distance between the sensors, hₛ, along the direction perpendicular to the fuel surface also changes. In other words, both the quantity hₛ and the fuel density estimation accuracy change according to the tank attitude.

Below, a study is performed showing how the fuel density estimation accuracy changes according with the relative position of the sensors. This study represents a general rule rather than a specific methodology for the relative positioning of the sensors. Indeed, a specific rule for the design of a cluster cannot be provided, since it depends on the single pressure sensor accuracy, on the accuracy with which the aircraft acceleration (and hence attitude) is known or determined, on the fuel density accuracy target as well as on the fuel quantity estimation accuracy required by the application. Therefore, a detailed study and simulations of the system performance must be performed after the overall requirements and sensors accuracies have been defined, to correctly design a cluster of sensors.

When the accuracy of the sensors involved in the fuel density estimation is taken into account, the estimated density \tilde{ρ} differs from the real one ρ by a quantity ±e_{ρ}. Indeed, the pressure measured by a sensor located over the area sᵢ is \tilde{p}ᵢ=p₁±eₚ, the acceleration is ã=a±eₐ and the relative height distance between two sensors is \tilde{h}ₛ=hₛ±eₕ, where eₚ, eₐ and eₕ are respectively the pressure sensor accuracy, the accuracy with which the acceleration is known or determined and the error in the evaluation of exact sensors position. Therefore

$$\begin{matrix} \pm {e}_{ρ} = \tilde{ρ} - ρ = \frac{{\tilde{p}}_{1} - {\tilde{p}}_{2}}{\tilde{a} ( {\tilde{h}}_{{s}_{1}} - {\tilde{h}}_{{s}_{2}} )} - \frac{{p}_{1} - {p}_{2}}{a ( {h}_{{s}_{1}} - {h}_{{s}_{2}} )} & Equation ( 4 ) \\ \pm {e}_{ρ} = \tilde{ρ} - ρ = \frac{{p}_{1} - {p}_{2} \pm 2 {e}_{p}}{( a \pm {e}_{a} ) [ ( {h}_{{s}_{1}} - {h}_{{s}_{2}} ) \pm 2 {e}_{h} ]} - \frac{{p}_{1} - {p}_{2}}{a ( {h}_{{s}_{1}} - {h}_{{s}_{2}} )} & Equation ( 5 ) \\ \pm {e}_{ρ} = \tilde{ρ} - ρ = \frac{{p}_{1} - {p}_{2}}{( a \pm {e}_{a} ) [ ( {h}_{{s}_{1}} - {h}_{{s}_{2}} ) \pm 2 {e}_{h} ]} \pm \frac{2 {e}_{p}}{( a \pm {e}_{a} ) [ ( {h}_{{s}_{1}} - {h}_{{s}_{2}} ) \pm 2 {e}_{h} ]} - \frac{{p}_{1} - {p}_{2}}{a ( {h}_{{s}_{1}} - {h}_{{s}_{2}} )} & Equation ( 6 ) \\ {lim}_{( {h}_{{s}_{1}} - {h}_{{s}_{2}} ) \to ∞} \pm {e}_{ρ} = {lim}_{( {h}_{{s}_{1}} - {h}_{{s}_{2}} ) \to ∞} \frac{{p}_{1} - {p}_{2}}{( a \pm {e}_{a} ) [ ( {h}_{{s}_{1}} - {h}_{{s}_{2}} ) \pm 2 {e}_{h} ]} \pm \frac{2 {e}_{p}}{( a \pm {e}_{a} ) [ ( {h}_{{s}_{1}} - {h}_{{s}_{2}} ) \pm 2 {e}_{h} ]} - \frac{{p}_{1} - {p}_{2}}{a ( {h}_{{s}_{1}} - {h}_{{s}_{2}} )} & Equation ( 7 )\end{matrix}$$

The term

$$\frac{2 {e}_{p}}{( a \pm {e}_{a} ) [ ( {h}_{{s}_{1}} - {h}_{{s}_{2}} ) \pm 2 {e}_{h} ]}$$

tends to zero, as (hₛ_{₁}−hₛ_{₂}) tends to infinity, and the term

$$\frac{{p}_{1} - {p}_{2}}{( a \pm {e}_{a} ) [ ( {h}_{{s}_{1}} - {h}_{{s}_{2}} ) \pm 2 {e}_{h} ]} \approx \frac{{p}_{1} - {p}_{2}}{a [ ( {h}_{{s}_{1}} - {h}_{{s}_{2}} ) ]}$$

since the terms eₕ and eₐ can be ignored as (hₛ_{₁}−hₛ_{₂}) tends to infinity. Therefore:

$${lim}_{( {h}_{{s}_{1}} - {h}_{{s}_{2}} ) \to ∞} \pm {e}_{ρ} = 0 \qquad Equation ( 8 )$$

Thus, it will be appreciated that the larger the relative distance between the two sensors responsible for determining the fuel density, the smaller the density estimation error. On the other hand, as this distance increases, the likelihood that the two sensors are simultaneously covered for small quantities of fuel decreases. The locations of the sensors must therefore be selected as a compromise between density estimation accuracy and fuel volume range for which the density can be estimated. Using multiple sensors distributed throughout the tank may increase the fuel volume range for which the density can be estimated.

Moreover, it can be seen that the density estimation error also depends on the pressure sensors and the accuracy with which the acceleration is known or measured.

### Fuel Density Distributions Using Clusters

It will be appreciated that estimating the fuel density between two distributed sensors, or clusters of sensors, as described above in relation to FIG. 1, is effectively a measure of the average fluid density p between the sensors, i.e. over the distance between the sensors, hₛ_{₁}−hₛ_{₂}. Thus, the fluid density determined between two spaced-apart sensors may be considered as an average or ‘global’ density within the tank. In practice, the fluid density may not be uniform within the tank. Indeed, especially within an aircraft fuel tank which may contain regions of different temperature and/or fuel composition, and which regions may significantly move within the tank due to the changes in attitude of the tank during the flight of the aircraft, typically, the fluid density may not be uniform. It will be appreciated that the distribution of fuel density and range of pressure changes experienced within an aircraft fuel tank may therefore be very different to those of a fuel tank of other motor vehicles such as cars, where there will typically only be a single type of fuel, and fewer significant changes in attitude.

The use of clusters of sensors containing two or more spaced apart pressure sensors, e.g. as shown in FIGS. 2, 3 and 4, however, means that each cluster may also be used to determine a fuel density by itself, in essentially the same manner described above. For instance, a cluster comprising at least a pair of simultaneously submerged pressure sensors, spaced apart by some fixed distance, may be used to estimate the density of fuel in the relatively small volume around the cluster, or specifically between the pair of pressure sensors within the cluster.

For example, referring back to Equations (1) to (3), the distance between the pressure sensors within a particular cluster will generally be known, or may be readily determined from the known spacing within the sensor and the current attitude or orientation of the tank. That is, as noted above, it is the distance along the direction perpendicular to the fuel surface 20 that is important. Thus, for instance, when the sensors are oriented perpendicularly to the fuel surface 20, as shown in FIG. 2, the distance, h_{g}′, may simply correspond to the known spacing between the sensors, as determined when designing the cluster. As the fuel tank tilts, the relevant distance may be reduced as shown in FIG. 3. The distance perpendicular to the fuel surface 20 in that case, hₛ″, may then be determined based on knowledge or measurement using a suitable sensor of the attitude or orientation of the fuel tank or cluster relative to the fuel surface.

Thus, each cluster may be used to determine a ‘local’ fuel density in the vicinity of the cluster, i.e. in the region between the pressure sensors within the cluster. By installing multiple clusters at different locations throughout the tank, e.g. as shown in FIG. 1, it is possible therefore to determine not only the average fuel density between the different locations, but also the local fuel density at each of the different locations, and hence the fluid density distribution through the tank. As mentioned above, knowledge of the distribution of the fluid density may be useful for refining estimations of other properties, including fuel volume, and may also be used for analysis or diagnostic purposes.

Again, referring to Equations (4) to (8), the fluid density estimation error for each cluster depends on the relative spacing between the pressure sensors, as well as the individual pressure sensor accuracy. The number and type of pressure sensors within the cluster, and their relative positioning, may therefore be selected to reduce this error, subject to e.g. size and cost constraints. Because the sensors are clustered into a single package prior to installation it will be appreciated that there is generally more control over the relative positioning, etc. than if the sensors were to be installed individually. The final structure of the cluster depends both on characteristics of the selected sensors, and of the fuel tank itself, as well as the overall system accuracy. Therefore, the optimum structure of a cluster may be dependent on all of these variables, as well as on the final system accuracy target. In general, a higher fuel estimation accuracy may be achieved either by increasing the number of pairs of sensors (or pairs of sensors within the cluster), or by increasing the distance between the sensors normal to the fuel surface.

It will be appreciated that the use of clusters in the context of fuel gauging and/or determining fuel density may therefore provide various advantages. For instance, in some embodiments, by clustering multiple pressure sensors together, a higher measurement accuracy may be achieved without increasing the accuracy of the pressure sensors themselves. Furthermore, the installation time may be reduced relative to the time to install a similar number of sensors individually, since the time to install a cluster of sensors may be the same or similar to the time to install an individual sensor. At least in some embodiments the installation requirements may also be simplified, e.g. as the wiring complexity of a cluster may be lower than the wiring complexity for a plurality of individual components. The clustering also allows the relative positions of the sensors within the package to be well-controlled, such that in some embodiments the cluster by itself may be used to determine a fuel density. By appropriate selection of the number and positions of the sensors within a cluster, the cluster may therefore provide a high-performance device capable of implementing relatively complex functionalities.

Although the techniques presented herein have been described with reference to particular embodiments, it will be understood by those skilled in the art that various changes in form and detail may be made without departing from the scope of the invention as set forth in the accompanying claims. For instance, although the techniques presented herein have been described in relation for a pressure-based fuel gauging system for an aircraft tank, it will be appreciated that the techniques may be re-used in different systems where the mass or volume of a liquid must be estimated through pressure-sensors.

1. A method of determining a density of a fluid within a tank such an aircraft fuel tank, the method comprising:
installing a first cluster of sensors at a first location within the tank, wherein the cluster of sensors comprises a plurality of sensors including at least two pressure sensors, and wherein the plurality of sensors within a cluster are installed simultaneously on a common frame or housing;
obtaining a first pressure measurement of the fluid within the tank using one or more of the pressure sensors of the first cluster of sensors; and
determining a density of the fluid using the obtained first pressure measurement.

2. The method of claim 1, wherein said first cluster of sensors comprises first and second spaced apart pressure sensors, the method comprising determining the fluid density at said first location by determining the fluid density between said first and second pressure sensors using pressure measurements obtained from said first and second spaced apart pressure sensors and the distance between said first and second pressure sensors measured in a direction perpendicular to the surface of the fluid.

3. The method of claim 1, further comprising obtaining a second pressure measurement of the fluid at a second location within the tank, wherein the second location is different from the first location and spaced apart from the first cluster of sensors, and using the obtained first and second pressure measurements and the distance between the first and second locations, measured in a direction perpendicular to the surface of the fluid, to determine the fluid density within the tank between the first and second locations.

4. The method of claim 3, comprising installing a second cluster of sensors at said second location within the tank, the second cluster of sensors comprising a plurality of sensors including at least two pressure sensors, wherein the plurality of sensors within a cluster are installed simultaneously on a common frame or housing, and wherein said second pressure measurement of the fluid is obtained using one or more of the pressure sensors of the second cluster of sensors.

5. The method of claim 1, comprising determining a distribution of fluid density within the tank by installing a plurality of clusters of sensors at a plurality of different locations throughout the tank, and determining the fluid density at each of said locations using pressure measurements obtained from first and second pressure sensors of each respective cluster of sensors.

6. The method of claim 1, comprising determining an orientation of the fuel tank and/or the cluster of sensors relative to the fluid surface, and optionally determining the distance between said first and second sensors or between said first and second locations, measured in a direction perpendicular to the surface of the fluid, based on the determined orientation of the fuel tank and/or cluster.

7. The method of claim 1, further comprising determining a volume or level of fluid within the tank using the determined fluid density.

8. The method of claim 1, wherein the density of the fluid, ρ, is determined using a relationship,
$$ρ = \frac{{p}_{1} - {p}_{2}}{{ah}_{s}} ,$$
where p₁ and p₂ are pressure measurements obtained at two different positions within the tank, hₛ, is the distance between said two positions measured in a direction perpendicular to the surface of the fluid, and the fluid is subject to an acceleration, a.

9. The method of claim 1, comprising:
installing said first cluster of sensors at said first location within the tank;
installing a second cluster of sensors at a second location within the tank, wherein the second cluster of sensors comprises a plurality of sensors including at least two pressure sensors, and wherein the plurality of sensors within the second cluster are installed simultaneously on a common frame or housing;
obtaining pressure measurements of the fluid using the pressure sensors of the first and second clusters of sensors;
determining a density of the fluid at said first location by determining the density of the fluid between a pair of pressure sensors of the first cluster of sensors;
determining a density of the fluid at said second location by determining the density of the fluid between a pair of pressure sensors of the second cluster of sensors; and
determining a density of the fluid between said first and second locations using pressure measurements obtained from the first and second cluster of sensors.

10. The method of claim 1, wherein each pressure sensor comprises a solid state and/or micro-electro-mechanical system (“MEMS”) pressure sensor.

11. The method of claim 1, wherein each cluster of sensors comprises a substantially closed housing, wherein the plurality of sensors are mounted within the housing, and wherein the at least two pressure sensors have a pressure sensing surface that forms part of the exterior surface of the housing.

12. A pressure gauging system for determining the density of fluid fuel tank, the system comprising:
one or more clusters of sensors, wherein each cluster of sensors comprises a plurality of sensors including at least two pressure sensors provided on a common frame or housing such that the plurality of sensors within each cluster can be installed simultaneously; and
one or more processors for receiving pressure measurements of the fluid from the pressure sensors of the one or more clusters of sensors, and processing the received measurements to determine a density of the fluid.

13. The system of claim 12, comprising a sensor for determining an orientation of the fuel tank relative to the fluid surface.

14. The system of claim 12, wherein each pressure sensor comprises a solid state and/or micro-electro-mechanical system (“MEMS”) pressure sensor.

15. The system of claim 12, wherein each cluster of sensors comprises a substantially closed housing, wherein the plurality of sensors are mounted within the housing, and wherein the at least two pressure sensors have a pressure sensing surface that forms part of the exterior surface of the housing.

16. An aircraft comprising:
A pressure gauging system for determining the density of a fluid fuel tank of the aircraft, the system comprising:
one or more clusters of sensors, wherein each cluster of sensors comprises a plurality of sensors including at least two pressure sensors provided on a common frame or housing such that the plurality of sensors within each cluster can be installed simultaneously; and
one or more processors for receiving pressure measurements of the fluid from the pressure sensors of the one or more clusters of sensors, and processing the received measurements to determine a density of the fluid.

17. The aircraft of claim 16, comprising a sensor for determining an orientation of the fuel tank relative to the fluid surface.

18. The aircraft of claim 16, wherein each pressure sensor comprises a solid state and/or micro-electro-mechanical system (“MEMS”) pressure sensor.

19. The aircraft of claim 16, wherein each cluster of sensors comprises a substantially closed housing, wherein the plurality of sensors are mounted within the housing, and wherein the at least two pressure sensors have a pressure sensing surface that forms part of the exterior surface of the housing.
